(19) United States
(12) Patent Application Publication
(10) Pub. No.: US 2008/0010983 A1
(43) Pub. Date: Jan. 17, 2008

(54) Low suction vacuum detector

(75) Inventors: Donald E. Morgan, Florissant, MO (US); David M. Lyle, St. Louis, MO (US)

Correspondence Address: SENNIGER POWERS, ONE METROPOLITAN SQUARE, 16TH FLOOR, ST LOUIS, MO, 63102, US

(73) Assignee: EMERSON ELECTRIC CO., St. Louis, MO (US)

(21) Appl. No.: 11/457,432

(22) Filed: Jul. 13, 2006

(51) Int. Cl. F16D 31/02

(52) U.S. Cl. 60/397

(57) ABSTRACT

A circuit inhibits power to a motor driving a pump when a vacuum condition is detected by a vacuum switch associated with the pump. The circuit is only responsive to an actuator for selectively supplying power to the motor after inhibiting power to the motor.

### FIELD OF THE INVENTION

The present invention generally relates to pumps which are de-energized when a vacuum condition occurs. In particular, the invention relates to jetted bath tubs which have pumps that are de-energized when objects block an intake to the pump.

### BACKGROUND OF THE INVENTION

Many jetted bath tubs and similar devices have a back up protection scheme such as illustrated in FIG. 1 to discontinue operation of a pump 100 driven by a motor 102. Usually, an actuator 104 responsive to an operator controls the operation of the motor 102. In general, the actuator 104 turns the motor on and off. A vacuum air valve 110 is associated with an inlet 108 to the pump 100. When a vacuum condition occurs, the air valve 110 is opened to allow air to enter the suction side of the pump 108. This somewhat unloads the pump reducing the suction allowing the blockage to be released. However, the pump continues to operate creating an immediate suction once the object is removed and sometimes recapturing the object.

### SUMMARY OF THE INVENTION

In one embodiment, the invention provides a back up protection when an inlet suction condition exists which minimizes the recapturing of an object which blocks an inlet. A vacuum switch responds to a vacuum condition associated with a pump. A motor driving the pump is disabled by the switch when the vacuum condition occurs. Once the motor has been disabled because of a vacuum condition, an operator must take action such as by actuating an actuator to energize the motor to drive the pump.

Other features will be in part apparent and in part pointed out hereinafter.

### BRIEF DESCRIPTION OF THE DRAWINGS

FIG. 1 is a block diagram of a system according to the prior art in which a vacuum air valve opens to reduce suction in a blockage situation.

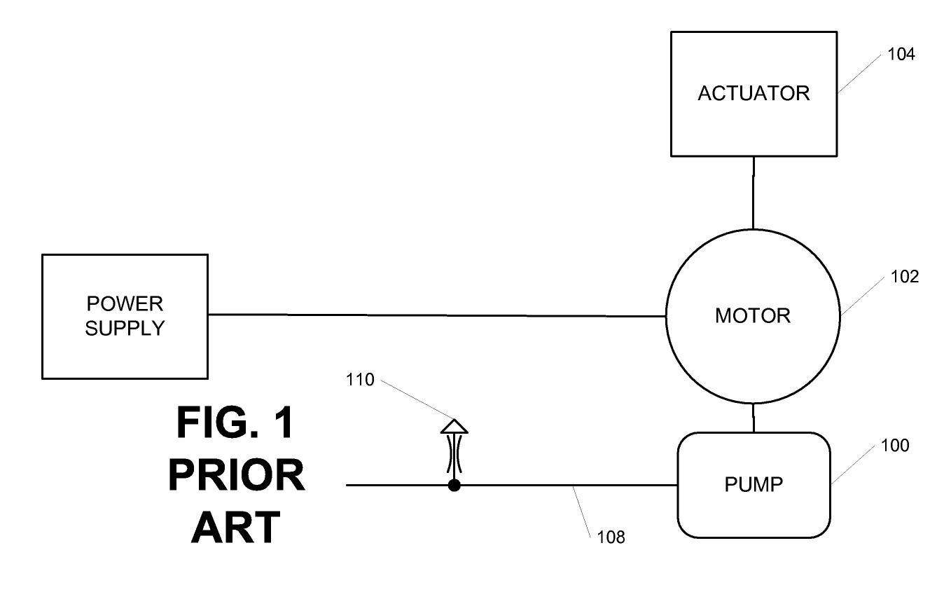

FIG. 2 is a block diagram of one embodiment of the invention.

FIG. 3 is a schematic circuit diagram of one embodiment of the invention.

Corresponding reference characters indicate corresponding parts throughout the drawings.

### DETAILED DESCRIPTION OF THE INVENTION

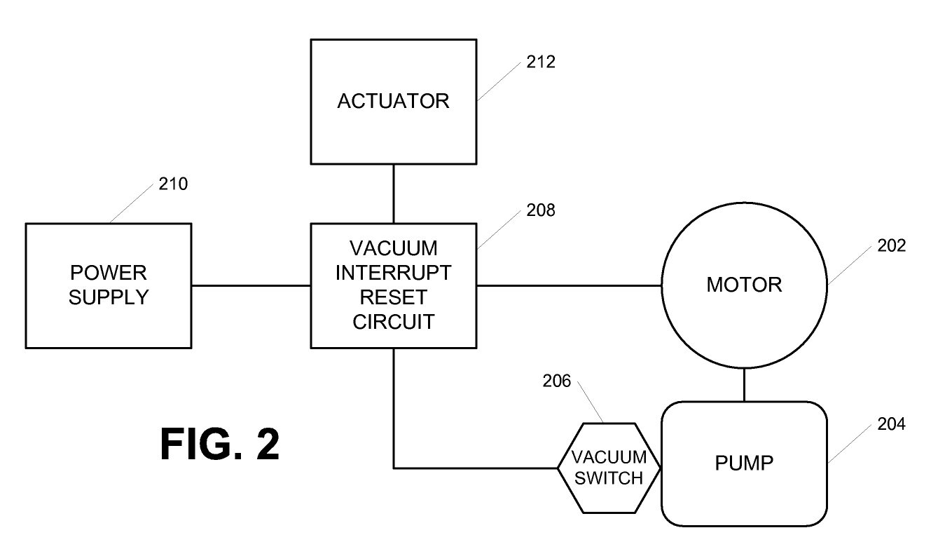

FIG. 2 illustrates one embodiment of the invention in block diagram form. A motor 202 drives a pump 204 which is part of a jetted bath tub or similar device. A vacuum switch 206 is positioned on the suction side of the pump 204 such as at the pump inlet or in tubing connected to the pump inlet. A vacuum interrupt reset circuit 208 controls power supplied from a power supply 210 to the motor 202. In one embodiment, a mechanical actuator 212 controlled by an operator provides a mechanical signal to the vacuum interrupt reset circuit 208 to turn the motor 202 on and off to actuate the pump 204. Thus, the circuit 208 is responsive to the actuator for selectively supplying power to the motor 202. In addition, the circuit 208 is responsive to the vacuum switch 206. When the switch 206 detects a vacuum condition it opens a relay coil circuit such as the circuit 208, power to the motor is inhibited so that operation of the pump 204 is discontinued and the vacuum condition is eliminated. In order to reset the circuit 208 and energize the motor 202 again, the circuit 208 is responsive to the actuator 212 to selectively supply power to the motor after power to the motor has been inhibited by the circuit 208.

Thus, in one form the invention comprises a method including detecting a vacuum condition associated with the pump 204 and selectively supplying power to the motor 202 driving the pump 204 in response to operator input via the actuator 212. The motor 202 is temporarily disabled by the switch 206 when the vacuum condition occurs. After disabling the motor 202 when the vacuum condition occurs, the circuit 208 selectively supplies power to the motor 202 only in response to operator input via the actuator 212 to reset the circuit 208.

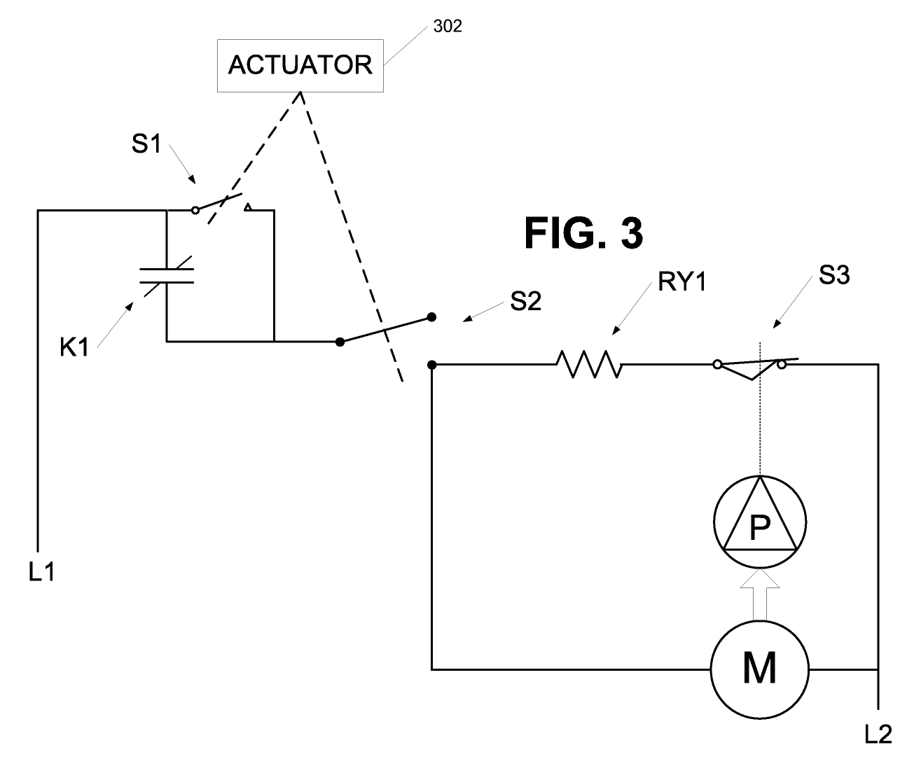

FIG. 3 illustrates one embodiment of the invention which incorporates three switches S1, S2 and S3, and a relay coil RY1 which controls contacts K1. Switches S1 and S2 are ganged and are operated by an air button or other actuator located on a surface of the jetted bath tub or similar device. Switch S1 is a momentary action switch and is normally open. When an operator actuates an actuator 302, switch S1 is momentarily closed. Switch S2 is an alternated action switch having either an up position in which it is open-circuited or a down position in which it is close-circuited. Switch S3 is a momentary action, vacuum switch which is normally closed and in series with the relay coil RY1. When the vacuum switch S3 detects a vacuum, it is momentarily opened.

In operation, an operator would actuate the actuator 302 such as by pressing an air button at the surface of the tub or other device causing the momentary switch S1 to momentarily close and causing the alternated action switch S2 to move in the down position to create a closed circuit which energizes the relay coil RY1 and the motor M to begin driving the pump P and to close the contacts K1. Switch S3 is normally closed to complete the circuit between power supply L1, L2. The closed contacts K1 and alternated action switch S2 in its down state complete a closed circuit and continues to supply power to the motor M and the relay coil RY1. When the switch S2 is moved to the up position by operation of the actuator 302, an open circuit is created and power to the relay RY1 and the motor M are interrupted and contacts K1 are opened.

If the momentary switch S3 opens momentarily in response to sensing a vacuum, it momentarily creates an open circuit that de-energizes the relay coil RY1 to open contacts K1 causing an open circuit which interrupts power to the motor M to discontinue operation of the pump P. At this point, the actuator 302 must be operated by the operator in order to reenergize the motor M and continue operation of the pump. In this embodiment, the first actuation of the actuator 302 resets the alternated action switch S2 to the up position and momentarily closes switch S1 which does not affect the operation of the motor because the circuit is open. The next actuation of actuator 302 simultaneously closes momentary switch S1 and moves switch S2 to the down position to close the circuit and energize the motor M and drive the pump P.

Thus, the pump P is shut off and the energization of the motor M is discontinued when the switch S3 detects a vacuum on the suction side of the pump P. The embodiment of the circuit illustrated in FIG. 3 must be reset to turn the power back on to the motor M. In one embodiment according to the invention the switches S1, S2, S3 and relay coil RY1 with contacts K1 are built within and integral with the motor M and part of the motor circuit. In this embodiment, the motor circuit receives two inputs, one from the actuator 302 and one from the vacuum switch S3.

According to one embodiment, the circuit as illustrated in FIG. 3 may be used with the pump P, driven by motor M, including a vacuum switch S3 detecting a vacuum condition associated with the pump P. The actuator 302 is controlled by an operator of the system as illustrated in FIG. 3. As described herein, the switches S1, S2 and S3 have a first (OFF) mode inhibiting power to the motor M. When the actuator 302 is operated by the operator, the switches change from the first mode to a second (ON) mode in which power is supplied to the motor to drive the pump P. The switches change from the second mode to a third (VACUUM) mode when a vacuum condition is detected by the switch S3 or the switches change from the second mode to the first mode when the operator actuates the actuator 302. The third mode inhibits power to the motor in response to the vacuum condition detected by the switch S3 and the switches change from the third mode to the first mode in response to operation of the actuator 302 by an operator.

Table 1 illustrates the three different modes of the circuit according to one embodiment of the invention.

TABLE 1

| | | | | | | MOTOR |
|---|---|---|---|---|---|---|
| MODE | RESPONSIVE TO | K1 | S1 | S2 | S3 | STATUS |
| OFF | ACTUATOR → ON | OPEN | CLOSED/OPEN | UP | CLOSED | OFF |
| ON | ACTUATOR → OFF | CLOSED | CLOSED/OPEN | DOWN | CLOSED | ON |
| | SWITCH S3→ VACUUM | | | | | |
| VACUUM | ACTUATOR → OFF | OPEN | OPEN | DOWN | OPEN/CLOSED | OFF |

In the OFF mode, contacts K1 are open, momentary switch S1 is initially closed when transitioning into the OFF mode and S1 is open after the transition, switch S2 is in the up position (creating an open circuit), and switch S3 is closed so that the motor is OFF. The OFF mode is a transition from either the ON mode or the VACUUM mode. To transition out of the OFF mode to the ON mode, the OFF mode is responsive to the actuator.

In the ON mode, contacts K1 are closed, momentary switch S1 is initially closed when transitioning into the ON mode and S1 is open after the transition, switch S2 is in the down position (creating a closed circuit), and switch S3 is closed so that the motor is ON. The ON mode is a transition from the OFF mode. To transition out of the ON mode to the OFF mode, the ON mode is responsive to the actuator. When a vacuum condition is detected, there is a transition out of the ON mode to the VACUUM mode, so that the ON mode is responsive to the vacuum switch.

In the VACUUM mode, contacts K1 are open, momentary switch S1 is open, switch S2 is in the down position, and momentary switch S3 is initially open when transitioning into the VACUUM mode. The motor is OFF. The VACUUM mode is a transition from the ON mode. To transition from the VACUUM mode to the OFF mode, the VACUUM mode is responsive to the actuator.

Table 2 illustrates a series of mode changes exemplifying one embodiment of operation of the invention. The right column indicates the action that causes a transition from one row to the next.

TABLE 2

| | | | | | | MOTOR | |
|---|---|---|---|---|---|---|---|
| | MODE | K1 | S1 | S2 | S3 | STATUS | ACTION |
| 1 | OFF | OPEN | CLOSED/OPEN | UP | CLOSED | OFF | ACTUATOR → |
| | | | | | | | ON |
| 2 | ON | CLOSED | CLOSED/OPEN | DOWN | CLOSED | ON | ACTUATOR → |
| | | | | | | | OFF |
| 3 | OFF | OPEN | CLOSED/OPEN | UP | CLOSED | OFF | ACTUATOR → |
| | | | | | | | ON |
| 4 | ON | CLOSED | CLOSED/OPEN | DOWN | CLOSED | ON | SWITCH S3 → |
| | | | | | | | VACUUM |
| 5 | VACUUM | OPEN | OPEN | DOWN | OPEN/CLOSED | OFF | ACTUATOR → |
| | | | | | | | OFF |
| 6 | OFF | OPEN | CLOSED/OPEN | UP | CLOSED | OFF | ACTUATOR → |
| | | | | | | | ON |

Row 1 illustrates the circuit in the OFF mode and illustrates that action by the operator manipulating the actuator changes the status of the circuit to the ON mode as shown in row 2. In row 2 in the ON mode transitioning from the OFF mode, switch S1 momentarily closes and switch S2 changes to the down position in response to the manipulation of the actuator. This closes the circuit to energize the motor M to drive the pump P and energizes the relay coil RY1 to close contacts K1.

Row 2 illustrates the circuit in the ON mode and illustrates that action by the operator manipulating the actuator changes the status of the circuit to the OFF mode as shown in row 3. In row 3 in the OFF mode transitioning from the ON mode, switch S1 momentarily closes and switch S2 changes to the up position in response to the manipulation of the actuator. This de-energizes the motor M to discontinue driving of the pump P and de-energizes the relay coil RY1 to open contacts K1.

Row 3 illustrates the circuit in the OFF mode and illustrates that action by the operator manipulating the actuator changes the status of the circuit to the ON mode as shown in row 4. In row 4 in the ON mode transitioning from the OFF mode, switch S1 momentarily closes and switch S2 changes to the down position in response to the manipulation of the actuator. This energizes the motor M to drive the pump P and energizes the relay coil RY1 to close contacts K1.

Row 4 illustrates the circuit in the ON mode and illustrates that the vacuum switch changes the status of the circuit to the VACUUM mode as shown in row 5. In row 5 in the VACUUM mode transitioning from the ON mode, switch S1 remains open, switch S2 remains in the down position and switch S3 opens momentarily in response to detecting a vacuum condition. This de-energizes the motor M to discontinue driving of the pump P and de-energizes the relay coil RY1 to open contacts K1.

Row 5 illustrates the circuit in the VACUUM mode and illustrates that action by the operator manipulating the actuator changes the status of the circuit to the OFF mode as shown in row 6. In row 6 in the OFF mode transitioning from the VACUUM mode, switch S1 closes momentarily, switch S2 changes to the up position in response to manipulation of the actuator and S3 remains closed. The relay RY1 and motor M continues to be de-energized and contacts K1 remain open.

Row 6 illustrates the circuit in the OFF mode and illustrates that action of the operator manipulating the actuator changes the status of the circuit to the ON mode as shown in row 2.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A system comprising:
A pump;
A motor driving the pump;
A switch detecting a vacuum condition associated with the pump;
An actuator controlled by an operator of the system;
A circuit responsive to actuation of the actuator for selectively supplying power to the motor, said circuit responsive to the vacuum switch for inhibiting power to the motor when the vacuum condition is detected by the vacuum switch, said circuit responsive to actuation of the actuator for selectively supplying power to the motor after inhibiting power to the motor.

2. The system of claim 1 wherein the circuit has a first mode inhibiting power to the motor, and a second mode supplying power to the motor, wherein in the first mode actuation of the actuator changes the circuit to the second mode, wherein in the second mode actuation of the actuator changes the circuit to the first mode.

3. The system of claim 2 wherein the second mode is responsive to the vacuum switch and changes the circuit to a third mode in response to the vacuum condition to inhibit power to the motor.

4. The system of claim 3 wherein the third mode is responsive actuation of the actuator to change the circuit to the first mode.

5. The system of claim 4 wherein the circuit comprises:
A first momentary normally open switch and a second alternate action switch wherein the first and second switches are ganged together and respond simultaneously to change state in response to the actuation of the actuator, said first and second switches positioned between the power supply and the motor.

6. The system of claim 5 wherein the circuit comprises a third normally closed switch responsive to the vacuum condition, said third switch in series with a relay having normally open contacts through which the power supply is connected to the motor.

7. The system of claim 1 wherein the circuit comprises:
A first momentary normally open switch and a second alternate action switch wherein the first and second switches are ganged together and respond simultaneously to change state in response to the actuation of the actuator, said first and second switches positioned between the power supply and the motor.

8. The system of claim 2 wherein the circuit comprises a third normally closed switch responsive to a vacuum condition, said third switch in series with a relay having normally open contacts through which the power supply is connected to the motor.

9. A method comprising:
selectively supplying power to a motor driving the pump in response to operator input;
disabling the motor when a vacuum condition occurs;
after disabling the motor when the vacuum condition occurs, selectively supply power to the motor only in response to operator input.

10. The method of claim 9 wherein a first mode inhibits power to the motor, and a second mode supplies power to the motor, wherein in the first mode operation actuation of an actuator changes the circuit to the second mode, wherein in the second mode operator actuation of the actuator changes the circuit to the first mode.

11. The method of claim 10 wherein the third mode is responsive to actuation of the actuator to change the circuit to the first mode.

12. A circuit for use with a pump, a motor driving the pump, a switch responsive to a vacuum condition associated with the pump, and an actuator controlled by an operator of the system, said circuit comprising:
A plurality of switches having:
a first mode (OFF) inhibiting power to the motor wherein the switches change from the first mode to a second mode (ON) in response to the actuator,
said second mode supplying power to the motor wherein the switches change from the second mode to a third mode (VACUUM) in response to the vacuum condition detected by the switch and wherein said switches change from the second mode to the first mode in response to the actuator,
said third mode inhibiting power to the motor in response to the vacuum condition detected by the switch wherein the switches change from the third mode to the first mode in response to the actuator.

13. The circuit of claim 12 wherein the switches have a first mode inhibiting power to the motor, and a second mode supplying power to the motor, wherein in the first mode actuation of the actuator changes the switches to the second mode, wherein in the second mode actuation of the actuator changes the switches to the first mode.

14. The circuit of claim 13 wherein the second mode is responsive to the vacuum switch and changes the switches to a third mode in response to the vacuum condition to inhibit power to the motor.

15. The circuit of claim 14 wherein the third mode is responsive actuation of the actuator to change the switches to the first mode.

16. The circuit of claim 15 wherein the switches comprise:
A first momentary normally open switch and a second alternate action switch wherein the first and second switches are ganged together and respond simultaneously to change state in response to the actuation of the actuator, said first and second switches positioned between the power supply and the motor.

17. The circuit of claim 16 wherein the switches comprise a third normally closed switch responsive to the vacuum condition for opening when the vacuum condition is detected by the switch, said third switch in series with a relay having normally open contacts through which the power supply is connected to the motor.

18. The circuit of claim 12 wherein the switches comprise:
A first momentary normally open switch and a second alternate action switch wherein the first and second switches are ganged together and respond simultaneously to change state in response to the actuation of the actuator, said first and second switches positioned between the power supply and the motor.

19. The circuit of claim 13 wherein the switches comprise a third momentary normally closed switch which opens responsive to the vacuum condition, said third switch in series with a relay having normally open contacts through which the power supply is connected to the motor.
